(19) United States
(12) Patent Application Publication
(10) Pub. No.: US 2007/0155874 A1
(43) Pub. Date: Jul. 5, 2007

(54) Flameretardant thermoplastic resin composition

(76) Inventors: Bok Nam Jang, Anyang-si (KR); Jin Hwan Choi, Anyang-si (KR); Jung Hwan Yoon, Gunpo-si (KR); In Chul Jung, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/715,113

(22) Filed: Mar. 7, 2007

Related U.S. Application Data
(63) Continuation-in-part of application No. PCT/KR06/05220, filed on Dec. 21, 2006.

(30) Foreign Application Priority Data
Dec. 19, 2005 (KR) 10-2005-0125390
Nov. 24, 2006 (KR) 10-2006-0116976

(51) Int. Cl. C08K 5/49; C08F 290/04

(52) U.S. Cl. 524/115; 524/504; 524/508

(57) ABSTRACT

Embodiments relate to a flame retardant thermoplastic resin composition, methods of preparing the flame retardant thermoplastic resin composition, and articles comprising the flame retardant thermoplastic resin composition.

### CROSS REFERENCE TO RELATED APPLICATIONS

This non-provisional application claims priority under U.S.C. § 119(a) from Korean Patent Application Nos. 10-2005-0125390 and 10-2006-00116976, filed on Dec. 19, 2005 and Nov. 24, 2006, which is herein incorporated by reference.

### BACKGROUND

1. Field

The present invention relates, generally, to a halogen-free flame retardant thermoplastic resin composition, and more particularly, to a thermoplastic resin composition having excellent flame retardancy and processability, which is characterized in that it comprises rubber-modified styrene copolymer resin, polyethylene terephthalate resin, phenolic resin, and an aromatic phosphoric acid ester compound.

2. Description of the Related Technology

In general, various thermoplastic resins, including rubber-modified styrene copolymer resins, have good processability, high impact strength, and a good external appearance, and thus are applied to a variety of electronic and electrical appliances, automobiles, construction materials, airplanes, and ships. While the range of plastic products that can be obtained from the thermoplastic resin composition has greatly widened, the need for imparting flame retardancy thereto in consideration of safety in the event of a fire is increasing.

### SUMMARY OF THE INVENTION

Certain preferred embodiments relate to a flame retardant thermoplastic resin composition. According to embodiments, the flame retardant thermoplastic resin composition may comprise a rubber modified styrene copolymer resin, a polyethylene terephthalate resin, a phenolic resin, and an aromatic phosphoric acid ester compound.

Certain preferred embodiments relate to a method of preparing the foregoing flame retardant thermoplastic resin composition. This method may comprise providing the components of the flame retardant thermoplastic resin composition described above and mixing the components.

Certain preferred embodiments relate to a molded product produced from the foregoing flame retardant thermoplastic resin composition.

### DETAILED DESCRIPTION OF EMBODIMENTS

Accordingly, the present inventors have evaluated the applicability of polyester resin, which is one of general purpose polymers, as a char source for the rubber-modified styrene copolymer resin. The polyester resin, having a chemical structure containing an aromatic group and oxygen atom on the main chain thereof, is considered to have the potential to form char. As the result of evaluation, however, a problem, in which polyester must be added in a much greater amount (at least 80 wt %) than the amount of polycarbonate or polyphenylene ether in order to assure equivalent flame retardancy, has arisen. The reason why polyester must be used in such a very large amount is that its ability to form char is remarkably inferior to that of polycarbonate or polyphenylene ether, and its LOI (which is the minimum oxygen concentration required for continuous combustion) is 21, which is much lower than 27 in the case of polycarbonate or 29 in the case of polyphenylene ether, as described in Polymer (published by Elsevier Science, 1975, vol. 16, pp. 615-620).

Thus, urgently required is the development of techniques for increasing flame retardancy without the use of a halogen flame retardant while maintaining excellent properties of conventional rubber-modified styrene copolymer resin.

As noted above, certain preferred embodiments relate to a flame retardant thermoplastic resin composition. The resin composition may comprise a rubber-modified styrene copolymer resin, a polyethylene terephthalate resin, a phenolic resin, and an aromatic phosphoric acid ester compound. The flame retardant thermoplastic resin composition may further comprise one or more additives such as an antidripping agent such as polytetraflouroethylene, an impact modifier, an antioxidant, a plasticizer, a heat stabilizer, a light stabilizer, a compatibilizer, a pigment, a dye, an inorganic additive, and mixtures thereof. The amounts of the phenolic resin and the aromatic phosphoric acid ester compound will be described with reference to 100 parts by weight of total weight of the rubber-modified styrene copolymer resin and the polyethylene terephthalate resin.

Certain preferred embodiments also relate to a method of preparing the foregoing flame retardant thermoplastic resin composition. This method may comprise the steps of providing the components of the flame retardant thermoplastic resin composition and mixing the components sufficient to form the composition. This method may further comprise the steps of molding the composition.

Individual components of embodiments of the flame retardant thermoplastic resin composition are specifically described below.

Rubber-Modified Styrene Copolymer Resin

The rubber modified styrene copolymer resin may comprise a resin polymer in which a grafted rubber phase polymer is dispersed in the form of particles in a continuous matrix of the copolymer of vinyl monomers. According to certain embodiments, the rubber-modified styrene copolymer resin may comprise a styrene-containing graft copolymer resin and a styrene-containing copolymer resin.

The styrene-containing graft copolymer resin may comprise a rubber phase polymer grafted with polymer or copolymer side chains.

The rubber is not particularly limited and may include, but is not limited to, diene rubber such as butadiene rubber, styrene-butadiene rubber, acrylonitrile-butadiene rubber, saturated rubber in which hydrogen is added to the diene rubber, isoprene rubber, chloroprene rubber, acrylic rubber such as butyl polyacrylate, a terpolymer of ethylene-propylene-diene monomers (EPDM), and mixtures thereof.

According to preferred embodiments, the rubber phase polymer may have an average particle size of about 0.05 to about 4 μm.

The rubber phase polymer may comprise about 5, 10, 15, 20, 25, 30, 35, 40, 45, 50, 55, 60, 65, or 70 parts by weight with reference to 100 parts by weight of the styrene-containing graft copolymer resin. In addition, the rubber phase polymer may comprise an amount in a range from about any of the foregoing number to any of the other foregoing numbers.

The polymer or copolymer side chains can be grafted onto the rubber phase polymer by methods known in the art. Various polymerization techniques may be used including emulsion polymerization, bulk polymerization, emulsion-suspension polymerization, emulsion-bulk polymerization, emulsion-solution polymerization and micro-suspension polymerization.

The side chains may comprise polymer or copolymer moieties or chains attached to the rubber particles or cores. The polymer or copolymer moieties or chains may comprise polymerized or co-polymerized aromatic vinyl monomers. The aromatic vinyl monomer is not particularly limited and may comprise a monomer comprising an aromatic group and a vinyl group and which is graft copolymerizable with the rubber phase polymer. Examples of the aromatic vinyl monomer include, but are not limited to, styrene, α-methylstyrene, nuclear-substituted styrene, and mixtures thereof. The aromatic vinyl monomer may comprise about 10, 15, 20, 30, 40, 50, 60, 70, 80, 85, or 90 parts by weight with reference to 100 parts by weight of the styrene-containing graft copolymer resin. In addition, the aromatic vinyl monomer may comprise an amount in a range from about any of the foregoing number to any of the other foregoing numbers.

The side chain polymer or copolymer moieties may further comprise additional polymerized or copolymerized monomers. The additional monomers may comprise monomers that are copolymerizable with the aromatic vinyl monomer. Examples include, but are not limited to, acrylonitrile, methylmethacrylonitrile, methylmethacrylate, N-substituted maleimide, maleic anhydride, and mixtures thereof. The copolymerizable monomer may comprise about 1, 5, 10, 20, 30, 40, 45, 50, or 55 parts by weight with reference to 100 parts by weight of the styrene-containing graft copolymer resin. In addition, the copolymerizable monomer may comprise an amount in a range from about any of the foregoing number to any of the other foregoing numbers.

The styrene-containing graft copolymer resin may comprise about 10, 15, 20, 30, 40, 50, 60, 70, 80, 90, or 100 parts by weight with reference to 100 parts by weight of the rubber-modified styrene copolymer resin. In addition, the styrene-containing graft copolymer resin may comprise an amount in a range from about any of the foregoing number to any of the other foregoing numbers.

The styrene-containing copolymer resin may comprise polymerized or copolymerized monomers comprising an aromatic vinyl monomer and an additional monomer copolymerizable with the aromatic vinyl monomer.

The aromatic vinyl monomer is not particularly limited and may comprise a monomer comprising an aromatic group and a vinyl group and which is graft copolymerizable with the rubber phase polymer. Examples of the aromatic vinyl monomer include, but are not limited to, styrene, α-methylstyrene, nuclear-substituted styrene, and mixtures thereof. The aromatic vinyl monomer may comprise about 40, 45, 50, 60, 70, 80, 90, 95, or 98 parts by weight with reference to 100 parts by weight of the styrene-containing copolymer resin. In addition, the aromatic vinyl monomer may comprise an amount in a range from about any of the foregoing number to any of the other foregoing numbers.

The additional monomer copolymerizable with the aromatic vinyl monomer may comprise, but are not limited to, acrylonitrile, methylmethacrylonitrile, methylmethacrylate, N-substituted maleimide, maleic anhydride, and mixtures thereof. The copolymerizable monomer may comprise about 1, 5, 10, 20, 30, 40, 45, 50, or 55 parts by weight with reference to 100 parts by weight of the styrene-containing copolymer resin. In addition, the copolymerizable monomer may comprise an amount in a range from about any of the foregoing number to any of the other foregoing numbers.

The styrene-containing copolymer resin may comprise about 0, 10, 20, 30, 40, 50, 60, 70, 80, or 90 parts by weight with reference to 100 parts by weight of the rubber-modified styrene copolymer resin.

The rubber-modified styrene copolymer resin may be prepared by separately preparing the styrene-containing graft copolymer and the styrene-containing copolymer and kneading the two resins together to form the rubber-modified styrene copolymer resin. Alternatively, the resin may be prepared by providing all of the components of the styrene-containing graft copolymer and the styrene-containing copolymer, mixing the components and polymerizing the mixture by known techniques in the art.

Examples of the rubber-modified styrene copolymer resin include, but are not limited to, acrylonitrile-butadiene-styrene (ABS) copolymer resin, acrylonitrile-styrene-acrylic rubber (ASA) copolymer resin, acrylonitrile-ethylenepropylene rubber-styrene (AES) copolymer resin, methylmethacrylate-butadiene-styrene (MBS) copolymer resin, and mixtures thereof.

The rubber-modified styrene copolymer resin may comprise about 30, 35, 40, 50, 60, 70, 80, 90, 95, or 98 parts by weight with reference to 100 parts by weight of the total weight of the rubber-modified styrene copolymer resin and the polyethylene terephthalate resin. In addition, the rubber-modified styrene copolymer resin may comprise an amount in a range from about any of the foregoing numbers to about any of the other foregoing numbers. In addition, the rubber-modified styrene copolymer resin may comprise a weight percent of the total weight of the rubber-modified styrene copolymer resin and the polyethylene terephthalate resin in a range from about any of the foregoing numbers to about any of the other foregoing numbers.

Polyethylene Terephthalate Resin

The polyethylene terephthalate resin is not particularly limited and may comprise a conventional, recycled or modified polyethylene terephthalate resin.

Examples of the polyethylene terephthalate resin include, but are not limited to, crystalline polyethylene terephthalate, semi-crystalline polyethylene terephthalate, amorphous polyethylene terephthalate, cyclohexane dimethanol-modified polyethylene terephthalate, isophthalic acid-modified polyethylene terephthalate, or glycol-modified polyethylene terephthalate may be used.

In certain preferred embodiments, the polyethylene terephthalate has a degree of crystallization of about 0, 1, 5, 10, 15, 20, 25, 30, 35, or 40%. In addition, the polyethylene terephthalate resin has a degree of crystallization in a range from about any of the foregoing amounts to about any of the other foregoing amounts.

The polyethylene terephthalate resin may comprise about 2, 5, 10, 20, 30, 40, 50, 60, 65, or 70 parts by weight with reference to 100 parts by weight of the total weight of the rubber-modified styrene copolymer resin and the polyethylene terephthalate resin. In addition, the polyethylene terephthalate resin may comprise an amount in a range from about any of the foregoing numbers to about any of the other foregoing numbers. Alternatively, the polyethylene terephthalate resin may comprise a weight percent of the total weight of the rubber-modified styrene copolymer resin and the polyethylene terephthalate resin in a range from about any of the foregoing numbers to about any of the other foregoing numbers.

Phenolic Resin

The phenolic resin may comprise polymers or copolymers comprising phenol structures in the main chain or side chains thereof. The phenol structures may be ortho, para, or meta-substituted phenols.

The phenolic resin may comprise a molecular weight of about 200, 300, 500, 1000, 2000, 3000, 4000, 5000, 5500, or 6000. In addition, the phenolic resin may comprise a molecular weight in a range from about any of the foregoing amounts to about any of the other foregoing amounts.

In addition, the phenolic resin of some embodiments may comprise a softening point of about 60° C. or higher.

Examples of the phenolic resin include, but are not limited to, phenolic novolac resin, resol phenolic resin, cresol novolac resin, phenolalkyl resin, bisphenol-A novolac resin, nonylphenol resin, t-butylphenol novolac resin, poly(p-hydroxystyrene), and dicyclopentadienephenol resin.

In certain preferred embodiments, the phenolic resin, in combination with the polyethylene terephthalate, result in compositions displaying improved flame retardance and processability.

The phenolic resin may comprise about 0.1, 1, 5, 10, 15, 20, 25, 30, 35, or 40 parts by weight with reference to 100 parts by weight of the total weight of the rubber-modified styrene copolymer resin and the polyethylene terephthalate resin. In addition, the phenolic resin may comprise an amount in a range from about any of the foregoing amount to about any of the other foregoing amounts.

Aromatic Phosphoric Acid Ester Compound

The aromatic phosphoric acid ester compound is not particularly limited. The aromatic phosphoric acid ester compound may be substituted with another phosphorous-containing compound such as red phosphorus, phosphonate, phosphinate, or phosphagen. According to certain preferred embodiments, the aromatic phosphoric acid ester compound may comprise a compound represented by Formula 1 below:

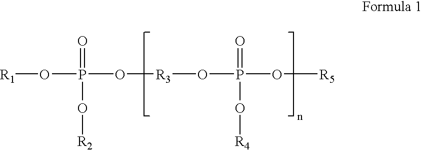

wherein R1, R2, R4, and R5 are each independently a C6˜C20 aryl group or alkyl-substituted aryl group, R3 is selected from among dialcohols such as resorcinol, hydroquinol, bisphenol-A, and bisphenol-S, and n is an integer from 0 to 5. The alkyl substituent of the alkyl-substituted aryl group may be a C1˜C14 alkyl group.

Examples of the aromatic phosphoric acid ester compound, in which n is 0 in Formula 1, include, but are not limited to, triphenyl phosphate, tricresyl phosphate, cresyldiphenyl phosphate, trixylyl phosphate, tri(2,4,6-trimethylphenyl)phosphate, tri(2,4-di-tert-butylphenyl)phosphate, and tri(2,6-di-tert-butylphenyl)phosphate.

Examples of the aromatic phosphoric acid ester compound, in which n is 1 in Formula 1, include, but are not limited to, resorcinol bis(diphenylphosphate), hydroquinol bis(diphenylphosphate), bisphenol-A bis(diphenylphosphate), resorcinol bis(2,6-di-tert-butylphenylphosphate), and hydroquinol bis(2,6-dimethylphenylphosphate).

The aromatic phosphoric acid ester compound, in which n is at least 2 in Formula 1, is present in the form of an oligomeric mixture.

The aromatic phosphoric acid ester compound may comprise an amount of about 1, 3, 5, 10, 15, 20, 25, 30, 35, or 40 parts by weight based on 100 parts by weight of the total weight of the rubber-modified styrene copolymer resin and the polyethylene terephthalate resin. In addition, the aromatic phosphoric acid ester compound may comprise an amount in a range from about any of the foregoing amount to about any of the other foregoing amounts.

Optional Additives

In addition, the flame retardant thermoplastic resin composition of the present invention may further comprise an additive alone or mixtures thereof. Examples of additives, include, but are not limited to, an antidripping agent such as polytetrafluoroethylene, an impact modifier, an antioxidant, a plasticizer, a heat stabilizer, a light stabilizer, a compatibilizer, a pigment, a dye, an inorganic additive, or mixtures thereof. The amount of the additive(s) is not particularly limited and may comprise about 0.1, 1, 5, 10, 15, 20, 30, 40, 50, 60, or 70 parts by weight with reference to 100 parts by weight of the total weight of the rubber-modified styrene copolymer resin and the polyethylene terephthalate resin. In addition, the additive(s) may comprise an amount in a range from about any of the foregoing amounts to about any of the other foregoing amounts.

Preparing the Flame Retardant Thermoplastic Resin Composition

Certain embodiments relate to a method of preparing the foregoing flame retardant thermoplastic resin composition. The method may comprise providing a rubber-modified styrene copolymer resin; providing a polyethylene terephthalate resin; providing a phenolic resin; providing an aromatic phosphoric acid ester compound; and mixing the rubber-modified styrene copolymer resin, the polyethylene terephthalate resin, the phenolic resin, and the aromatic phosphoric acid ester compound. The method may further comprise providing additives such as an antidripping agent such as polytetrafluoroethylene, an impact modifier, an antioxidant, a plasticizer, a heat stabilizer, a light stabilizer, a compatibilizer, a pigment, a dye, an inorganic additive, or mixtures thereof. The method may further comprise molding the resin composition.

According to certain embodiments, the above components are mixed together all at once. According to other embodiments, the components may be mixed together one at a time.

Formulating and mixing the components may be accomplished by any method known to a person having ordinary skill in the art. In some embodiments, the mixing may occur in a pre-mixing state in a device such as a ribbon blender, followed by further mixing in a Henshel mixer, Banbury mixer, a single screw extruder, a twin screw extruder, a multi screw extruder or a cokneader. In certain embodiments, the components mixed and melt extruded in the form of pellets.

Articles Made From the Flame Retardant Thermoplastic Resin Composition

Certain preferred embodiments relate to articles made from the foregoing flame retardant thermoplastic resin composition. The resin composition may be extruded or may be molded using various molding techniques such as a mold box or a melt-molding device. Further, in some embodiments, the resin composition may be molded into pellets. In some embodiments, the composition can be molded into various shapes using, for example, injection molding, injection compression molding, extrusion molding, blow molding, pressing, vacuum forming or foaming.

In certain embodiments, the thermoplastic resin composition may be formed into various articles including, but not limited to, electrical and electronic appliances such as housing of office automation instruments and TV sets.

The description of preferred embodiments may be better understood with reference to the following examples which are not intended to limit the scope of the claims.

### EXAMPLES

A description of how the components of the Examples and Comparative Examples were prepared follows. Please note that the “Comparative Examples” are not intended to represent and prior art and are not meant to limit the invention in any way. The Comparative Examples are used for illustrative purposes only.

Preparation of the Rubber Modified Styrene Copolymer Resin

The rubber modified styrene copolymer resin used in the Examples and the Comparative Examples was prepared by kneading together a styrene-containing graft copolymer resin and a styrene-containing copolymer resin. The styrene-containing graft copolymer resin comprised 40 parts by weight with reference to 100 parts by weight of the rubber modified styrene copolymer resin. The styrene-containing copolymer resin comprised 60 parts by weight with reference to 100 parts by weight of the rubber modified styrene copolymer resin.

The styrene-containing graft copolymer resin used to prepare the rubber modified styrene copolymer resin was ABS in powder form. The ABS was prepared by blending, in a reactor, 50 parts by weight of butadiene rubber latex, based on the monomer content thereof, 36 parts by weight of styrene and 14 parts by weight of acrylonitrile. Several materials were then added to the blend. Note that the following amounts are given with reference to 100 parts by weight of the total monomer content of the blend comprising the butadiene rubber latex, the stryrene, and the acrylonitrile. To the blend was then added 150 parts by weight of deionized water, 1.0 part by weight of potassium oleate, 0.4 parts by weight of cumenhydroperoxide, 0.2 parts by weight of a mercaptan-containing chain transfer agent, 0.4 parts by weight of glucose, 0.01 parts by weight of ferrous sulfate hydrate, and 0.3 parts by weight of sodium pyrophosphate. The blend was allowed to react at 75° C. for 5 hours to obtain graft copolymer resin latex. To the latex was added 0.4 parts by weight of sulfuric acid with reference to 100 parts by weight of the total solid content of the resin. The composition then coagulated.

The styrene-containing copolymer resin used to prepare the rubber modified styrene copolymer resin was SAN in powder form. The SAN was prepared by blending 72 parts by weight of styrene and 28 parts by weight of acrylonitrile. Several materials were then added to the blend. Note that the following amounts are given with reference to 100 parts by weight of the blend comprising the styrene and the acrylonitrile. To the blend was then added 120 parts by weight of deionized water, 0.2 parts by weight of azobisisobutyronitrile, 0.4 parts by weight of tricalcium phosphate, and 0.2 parts by weight of a mercaptan-containing chain transfer agent. The blend was then heated from room temperature to 80° C. in 90 min and held at that temperature for 240 min, producing a product comprising 25 wt % acrylonitrile. The product was then washed with water, dehydrated, and dried. The styrene-acrylonitrile copolymer resin formed had a weight average molecular weight ranging from 180,000 to 200,000.

Preparation of the Polyethylene Terephthalate Resin

Two different polyethylene terephthalate resin compounds were used in the Examples and Comparative Examples.

In the Examples and some of the Comparative Examples, Poly(ethylene-1,4-cyclohexanedimethylene terephthalate) (PETG) (SKYGREEN K2012 Grade, available from SK Chemicals, Korea) was used.

In the Comparative Examples, polybutylene terephthalate (PBT) resin (PBT A-9695 Grade, available from Saehan Inc., Korea) was used.

Preparation of the Phenolic Resin

In the Examples and Comparative Examples, KPH-2002 Grade, available from Kolon Chemical Co. Ltd., Korea, was used as the phenolic resin.

Preparation of the Aromatic Phosphoric Acid Ester Compound

In the examples and comparative examples, resorcinol bis(di-2,6-xylenylphosphate), PX-200 Grade, available from Dihachi Co. Ltd., Japan, was used as the phosphoric acid ester compound.

### Examples 1-2 and Comparative Examples 1-7

The components were blended in amounts as shown in Table 1 below and then extruded in the form of pellets at 220-250° C. using a twin-screw extruder.

The pellets were dried at 80° C. for 3 hours and then injection molded using an 80z injection molding machine under conditions of a molding temperature of 230° C. and a mold temperature of 60° C., thus producing specimens for the evaluation of flame retardancy. The flame retardancy of the specimens was determined according to UL 94 flame retardant standard. Izod impact strength was measured according to ASTM D-256.

TABLE 1

| | Exam- | | | | | | | | |
|---|---|---|---|---|---|---|---|---|---|
| | ple | | Comparative Example | | | | | | |
| No. | 1 | 2 | 1 | 2 | 3 | 4 | 5 | 6 | 7 |
| Rubber Modified Styrene Graft | 70 | 60 | 70 | 50 | 30 | 100 | 100 | 100 | 70 |
| Copolymer | | | | | | | | | |
| (ABS Resin) | | | | | | | | | |
| PETG | 30 | 40 | 30 | 50 | 70 | — | — | — | — |
| PBT | — | — | — | — | — | — | — | — | 30 |
| Phenolic Novolac Resin | 5 | 3 | — | — | — | 5 | 10 | 20 | 10 |
| Aromatic Phosphoric Acid Ester | 18 | 18 | 23 | 23 | 23 | 18 | 18 | 18 | 18 |
| Compound | | | | | | | | | |
| ⅛″ Izod Impact Strength | 15 | 14 | 16 | 14 | 13 | 18 | 12 | 10 | 8 |
| (kgf · cm/cm) | | | | | | | | | |
| Flame Retardancy | V-1 | V-1 | Fail | Fail | Fail | Fail | Fail | Fail | Fail |
| (UL 94, 2.5 mm thick) | | | | | | | | | |

As is apparent from Table 1, the products of Examples 1 and 2 could be seen to maintain excellent impact strength and exhibit flame retardancy remarkably superior to that of Comparative Examples 1-3. In particular, the product of Comparative Example 3, in which 70 parts by weight of polyethylene terephthalate resin was used, failed a UL 94 vertical flame test. In contrast, the product of Example 1, comprising only 30 parts by weight of polyethylene terephthalate resin and a small amount of phenolic resin, displayed a V-1 rated flame retardancy.

In Comparative Examples 4-7, the compositions lacking polyethylene terephthalate resin did not exhibit flame retardancy even when the aromatic phosphoric acid ester compound was used in the same amount as Examples 1 and 2 and the phenolic resin was used in a larger amount compared to Examples 1 and 2. Thus, a synergy between the polyethylene terephthalate and the phenolic resin is apparent in the Examples.

Embodiments of the flame retardant thermoplastic resin composition comprising a rubber-modified styrene resin, a polyethylene terephthalate resin, a phenolic resin, and an aromatic phosphoric acid ester compound, may result in drastic improvement of flame retardancy even in the presence of a relatively small amount of polyethylene terephthalate resin. In addition, environmental problems, due to the use of a halogen flame retardants, and economical and processing problems caused by polycarbonate resin and polyphenylene ether resin, can be addressed.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A flame retardant thermoplastic resin composition, comprising:
about 40 to about 95 parts by weight of a rubber-modified styrene copolymer resin;
about 60 to about 5 parts by weight of a polyethylene terephthalate resin, wherein the total weight of the rubber-modified styrene copolymer resin and the polyethylene terephthalate resin is 100 parts by weight;
about 1 to about 30 parts by weight of a phenolic resin; and
about 5 to about 30 parts by weight of an aromatic phosphoric acid ester compound.

2. The flame retardant thermoplastic resin composition according to claim 1, wherein the rubber-modified styrene copolymer resin comprises a styrene-containing graft copolymer resin and a styrene-containing copolymer resin.

3. The flame retardant thermoplastic resin composition according to claim 2, wherein the styrene-containing graft copolymer resin comprises a rubber phase polymer, a copolymerized aromatic vinyl monomer, and a copolymerized monomer copolymerizable with the aromatic vinyl monomer, wherein the rubber phase polymer comprises about 5 to about 70 parts by weight, the copolymerized aromatic vinyl monomer comprises about 10 to about 90 parts by weight, and the copolymerized monomer copolymerizable with the aromatic vinyl monomer comprises about 1 to about 60 parts by weight, and wherein the amounts are given with reference to 100 parts by weight of the styrene-containing graft copolymer resin.

4. The flame retardant thermoplastic resin composition according to claim 3, wherein the rubber phase polymer is selected from the group consisting of butadiene rubber, styrene-butadiene rubber, acrylonitrile-butadiene rubber, saturated rubber, isoprene rubber, chloroprene rubber, butyl polyacrylate, a terpolymer of ethylene-propylene-diene monomers (EPDM), and mixtures thereof.

5. The flame retardant thermoplastic resin composition according to claim 4, wherein the copolymerized aromatic vinyl monomer is selected from the group consisting of copolymerized styrene, α-methylstyrene, nuclear-substituted styrene, and mixtures thereof.

6. The flame retardant thermoplastic resin composition according to claim 5, wherein the copolymerized monomer copolymerizable with the aromatic vinyl monomer is selected from the group of copolymerized monomers consisting of acrylonitrile, methylmethacrylonitrile, methylmethacrylate, N-substituted maleimide, maleic anhydride, and mixtures thereof.

7. The flame retardant thermoplastic resin composition according to claim 2, wherein the styrene-containing copolymer resin comprises a copolymerized aromatic vinyl monomer and a copolymerized monomer copolymerizable with the aromatic vinyl monomer, wherein the copolymerized aromatic vinyl monomer comprises about 40 to about 98 parts by weight, and the copolymerized monomer copolymerizable with the aromatic vinyl monomer comprises about 1 to about 60 parts by weight, and wherein the amounts are given with reference to 100 parts by weight of the styrene-containing copolymer resin.

8. The flame retardant thermoplastic resin composition according to claim 7, wherein the copolymerized aromatic vinyl monomer is selected from the group consisting of copolymerized styrene, α-methylstyrene, nuclear-substituted styrene, and mixtures thereof.

9. The flame retardant thermoplastic resin composition according to claim 8, wherein the copolymerized monomer copolymerizable with the aromatic vinyl monomer is selected from the group of copolymerized monomers consisting of acrylonitrile, methylmethacrylonitrile, methylmethacrylate, N-substituted maleimide, maleic anhydride, and mixtures thereof.

10. The flame retardant thermoplastic resin composition according to claim 1, wherein the rubber-modified styrene copolymer resin is selected from the group consisting of acrylonitrile-butadiene-styrene (ABS) copolymer resin, acrylonitrile-styrene-acrylic rubber (ASA) copolymer resin, acrylonitrile-ethylenepropylene rubber-styrene (AES) copolymer resin, methylmethacrylate-butadiene-styrene (MBS) copolymer resin, and mixtures thereof

11. The flame retardant thermoplastic resin composition according to claim 1, wherein the polyethylene terephthalate resin is amorphous polyethylene terephthalate resin.

12. The flame retardant thermoplastic resin composition according to claim 1, wherein the polyethylene terephthalate resin comprises about 30 to about 10 parts by weight with reference to 100 parts by weight of the total weight of the rubber-modified styrene copolymer resin and the polyethylene terephthalate resin.

13. The flame retardant thermoplastic resin composition according to claim 1, wherein the phenolic resin has an average molecular weight in a range from about 400 to about 5,000.

14. The flame retardant thermoplastic resin composition according to claim 1, wherein the phenolic resin is selected from the group consisting of phenolic novolac resin, resol phenolic resin, cresol novolac resin, phenolalkyl resin, bisphenol-A novolac resin, nonylphenol resin, t-butylphenol novolac resin, poly(p-hydroxystyrene), and dicyclopentadienephenol resin.

15. The flame retardant thermoplastic resin composition according to claim 1, wherein the phenolic resin comprises about 15 to about 30 parts by weight with reference to 100 parts by weight of the total weight of the rubber-modified styrene copolymer resin and the polyethylene terephthalate resin.

16. The composition according to claim 1, wherein the aromatic phosphoric acid ester compound is represented by Formula 1 below: 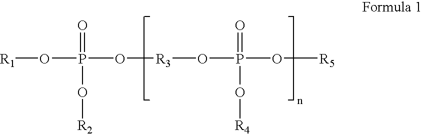
wherein R1, R2, R4, and R5 are each independently a C6˜C20 aryl group or alkyl-substituted aryl group, R3 is selected from the group consisting of dialcohols, including resorcinol, hydroquinol, bisphenol-A, and bisphenol-S, and n is an integer from 0 to 5

17. The flame retardant thermoplastic resin composition according to claim 1, further comprising an additive selected from the group consisting of an antidripping agent, an impact modifier, an antioxidant, a plasticizer, a heat stabilizer, a light stabilizer, a compatibilizer, a pigment, a dye, an inorganic additive, and mixtures thereof.

18. A flame retardant thermoplastic resin composition, comprising:
a rubber-modified styrene copolymer resin;
a polyethylene terephthalate resin;
a phenolic resin; and
an aromatic phosphoric acid ester compound.

19. A flame retardant thermoplastic resin composition according to claim 18, wherein the rubber-modified styrene copolymer resin comprises about 30 to about 98 parts by weight, the polyethylene terephthalate resin comprises about 70 to about 1 parts by weight, the phenolic resin comprises about 0.1 to about 40 parts by weight, the aromatic phosphoric acid ester compound comprises about 1 to about 40 parts by weight, and wherein all of the amounts are given with reference to 100 parts by weight of the total weight of the rubber-modified styrene copolymer resin and the polyethylene terephthalate resin.

20. A method of making a shaped thermoplastic resin composition, the method comprising:
providing a mass of the composition of claim 1; and
molding the mass into a molded article.

21. The method of claim 20, wherein providing a mass comprises:
providing about 40 to about 95 parts by weight of a rubber-modified styrene copolymer resin;
providing about 60 to about 5 parts by weight of a polyethylene terephthalate resin, wherein the total weight of the rubber-modified styrene copolymer resin and the polyethylene terephthalate resin is 100 parts by weight;
providing about 1 to about 30 parts by weight of a phenolic resin;
providing about 5 to about 30 parts by weight of an aromatic phosphoric acid ester compound; and
mixing the rubber-modified styrene copolymer resin, the polyethylene terephthalate resin, the phenolic resin, and the aromatic phosphoric acid ester compound to form a mass.

22. The flame retardant thermoplastic resin composition according to claim 1, wherein the composition is in the form of a molded article.

23. The flame retardant thermoplastic resin composition according to claim 22, wherein the molded article is at least a portion of an electronic device.
